(19) United States
(12) Patent Application Publication
(10) Pub. No.: US 2006/0129894 A1
(43) Pub. Date: Jun. 15, 2006

(54) Verifying system and verifying method

(75) Inventor: Akiko Marubashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/281,620

(22) Filed: Nov. 18, 2005

(30) Foreign Application Priority Data
Nov. 26, 2004 (JP) 2004-342395

(51) Int. Cl. G06F 11/00

(52) U.S. Cl. 714/38

(57) ABSTRACT

A verifying system according to an embodiment of the invention includes: a host computer; and a user system, the host computer sending a command based on a script to the user system to verify a command execution result with the host computer, the user system including: an instruction input unit inputting a user's instruction; a processing monitoring unit monitoring a processing executed in response to an instruction input with the instruction input unit; and a transmitter transmitting processing information based on the processing monitored by the processing monitoring unit to the host computer, and the host computer including: a processing information receiver receiving the processing information from the user system; a script creating unit creating a script that records commands corresponding to the processing information received with the processing information receiver in a time-series manner; and a script storage unit storing the script created by the script creating unit.

### BACKGROUND OF THE INVENTION

1. Field of the Invention

The present invention relates to a verifying system and a verifying method, and more specifically to a verifying system and a verifying method, which verify a user system using a computer.

2. Description of Related Art

In recent years, a computer-installed user system for controlling an automatic vending machine or car audio system has required complex control and a larger number of operation verifying steps. In general, when any malfunction is detected during a given operation, the operation is repeated after the correction to verify a normal operation after the correction.

In other words, the user system should repeat the same operation before and after the correction. Thus, recent complicated user systems need to expend much time and effort in executing this work in some cases. In addition, when someone operates the user system, there is a possibility that he/she executes an operation different from the operation the malfunction of which is detected by mistake. At this time, there is a fear that whether or not the correction has succeeded cannot be checked if he/she does not realize his/her errors. Alternatively, in the case where the operation of which the malfunction is detected depends on an operation period, an operator cannot repeat such a time-dependent operation in some cases. In such cases, it is considerably difficult to check whether or not the malfunction is corrected.

To overcome this problem, there is proposed a method of automating an operation by issuing a command to repeat the verified operation from a host computer connected to a user system (see Japanese Unexamined Patent Publication No. 2002-189617, for example) . According to this method, a script recording a sequence of commands is input to the host computer to automatically send the commands to the user system and let the user system execute a processing equivalent to the user operation in response to the received command, facilitating the reverification after the correction.

However, such a method has a problem that an operation verifier needs to create a script. For creating the script, the command corresponding to the operation of the user system is analyzed to describe a script corresponding to the command, and in addition, since the operator describes the script, any human error occurs upon the description. Further, in the case of verifying the time-dependent operation, it is necessary to consider a timing for creating a script upon the creation of the script, so it is difficult to create a script for checking the malfunction according to the script creation timing.

### SUMMARY OF THE INVENTION

A verifying system according to an aspect of the invention includes a user system and a host computer for sending a command based on a script to the user system and verifying a command execution result. The user system includes an instruction input unit for inputting a user's instruction, a processing monitoring unit for monitoring a processing executed in accordance with an instruction input by the instruction input unit, and a transmitter for transmitting processing information based on the processing monitored by the processing monitoring unit to the host computer. The host computer includes a processing information receiver for receiving the processing information from the user system, a script creating unit for creating a script that records-commands corresponding to the processing information received by the processing information receiver in a time-series manner, and a script storage unit for storing the script created by the script creating unit. According to the system configuration, an instruction is issued to the actual operation of the user system, and the processing monitoring unit monitors the processing. The processing information is sent to the host computer, and the script creating unit of the host computer automatically creates a script, whereby it is possible to create a script for causing the user system to repeat the verified operation without describing the script to reduce the number of verifying steps.

According to another aspect of the invention, a verifying method for transmitting a command to a user system based on a script from a host computer and verifying a command execution result at the host computer is provided. The method includes inputting an instruction at the user system, monitoring a processing based on the instruction at the user system, transmitting processing information based on the monitored processing from the user system to the host computer, and receiving the processing information at the host computer to create a script that records commands corresponding to the processing in a time-series manner. According to the method, an instruction is issued to the actual operation of the user system, and the processing executed in response to the input instruction is monitored. The processing information based on the monitored processing is sent to the host computer, and the script creating unit of the host computer automatically creates a script, whereby it is possible to create a script for causing the user system to repeat the verified operation without describing the script to reduce the number of verifying steps.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the configuration of a verifying system according to an embodiment of the present invention;

FIG. 2 is a flowchart showing a processing flow of the verifying system according to the embodiment of the present invention;

FIG. 3 is a flowchart showing a flow of a monitoring script execution processing according to the embodiment of the present invention;

FIG. 4 is a flowchart showing a monitoring processing flow according to the embodiment of the present invention;

FIG. 5 is a flowchart showing a script creation processing flow according to the embodiment of the present invention;

FIG. 6 is a block diagram showing the configuration of the verifying system according to the embodiment of the present invention;

FIG. 7 shows an example of input information according to the embodiment of the present invention;

FIG. 8 shows an evaluating script translation rule example according to the embodiment of the present invention;

FIG. 9 shows an evaluation script example according to the embodiment of the present invention;

FIG. 10 is a block diagram showing the configuration of a verifying system according to an embodiment of the present invention;

FIG. 11 shows a monitoring script translation rule according to the embodiment of the present invention; and

FIG. 12 shows a monitoring script example according to the embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

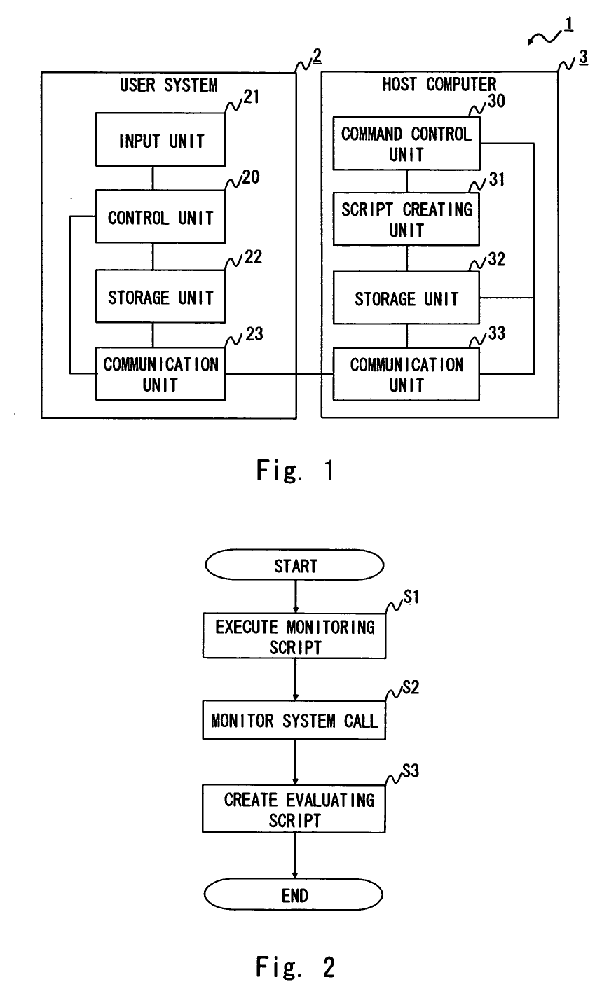

FIG. 1 shows the configuration of a verifying system according to a first embodiment of the present invention. A verifying system 1 includes a user system 2 and a host computer 3. The user system 2 is communicable with the host computer 3 by means of independent communication units to execute data transmission/reception therebetween. As the communication units, RS-232C (recommended standard 232-C) or USB (universal serial bus) is widely used, but a wireless communication unit may be used insofar as the data transmission/reception can be executed.

The user system 2 is a verification target, which includes a control unit 20, an input unit 21, a storage unit 22, and a communication unit 23. The control unit 20 controls various operations of the user system 2. This control includes monitoring a processing executed in response to an instruction issued with the input unit 21 and executing the processing. The control unit 20 executes the control by a special processor executing a program stored in the storage unit 22. The input unit 21 is used by a user to issue an instruction to the user system 2. The instruction is issued by pressing a button in most cases, but the present invention is not limited thereto. The input instruction is sent to the control unit 20.

The storage unit 22 is a memory for storing information about operations of the user system 2. This information includes a program for running the user system 2 and data such as a flag necessary for the system operation and a variable. The communication unit 23 is used for data exchange with the host computer 3.

The host computer 3 is a computer for verifying the normal operation of the user system 2, which includes a command control unit 30, a script creating unit 31, a storage unit 32, and a communication unit 33. The command control unit 30 executes control for executing a verifying command and sending a command described in a script stored in the storage unit 32 by use of the communication unit 33. The script creating unit 31 records a series of commands corresponding to processing information received from the user system 2 through the communication unit 33 in a time-series manner to create a script. The created script is stored in the storage unit 32. The command control unit 30 and the script creating unit 31 execute control in such a manner that the program stored in the storage unit 32 is executed by the CPU (central processing unit).

The storage unit 32 is a memory storing information about operations of the host computer 3. This information includes a program for running the host computer 3, data such as a flag necessary for the operation and a variable, and a script created with the script creating unit 31. The communication unit 33 functions to execute data exchange with the user system 2.

Referring next to a flowchart of FIG. 2, a processing flow of the verifying system according to the first embodiment of the present invention is described.

First of all, a monitoring script is executed (S1). The monitoring script lists commands indicating which value in a user system should be monitored upon the verification of the user system. The monitoring script is stored in the storage unit 32 of the host computer 3, and the commands described in the monitoring script are sent to the user system 2 through the communication unit 33 under the control of the command control unit 30 of the host computer 3.

Upon receiving the commands from the host computer 3, the user system 2 inputs the commands to the control unit 20 through the communication unit 23. The control unit 20 executes the monitoring processing in accordance with the input commands (S2) The monitoring processing is a processing of sending information about a processing to be processed or a flag or memory value to the host computer 3 through the communication unit 23. This monitoring processing is not executed at the time of executing the commands but executed throughout the operation verification processing. That is, during the operation verification processing, a flag or memory value to be monitored is sent to the host computer 3 and verified with the host computer 3.

Finally, the script is created (S3). The script to be created is a script that lists commands for causing the user system 2 to execute operations to be verified, unlike the aforementioned monitoring script. This script is called an evaluating script.

It is necessary to input an instruction to execute an operation as a verification target at the beginning in order to create the evaluating script. This instruction is input by use of the input unit 21. The instruction input with the input unit 21 is processed with the control unit 20, and this processing is monitored. If the monitored processing matches a processing that is being executed, the processing information is sent to the host computer 3 through the communication unit 23 based on the monitored processing.

Receiving the processing information sent from the user system 2 through the communication unit 33, the host computer 3 stores the received processing information in the storage unit 32 in a time-series manner by use of the script creating unit 31. A command is created in accordance with the stored processing information. After commands corresponding to all processing information have been recorded, the creation of the evaluating script is completed. When the user system 2 is corrected due to the malfunction found during the operation verification, the operation verification should be executed again, but the command described in the evaluating script created with the host computer 3 is sent to the user system 2, and the user system 2 executes the received command, so there is no need to input the instruction to the input unit 21 again.

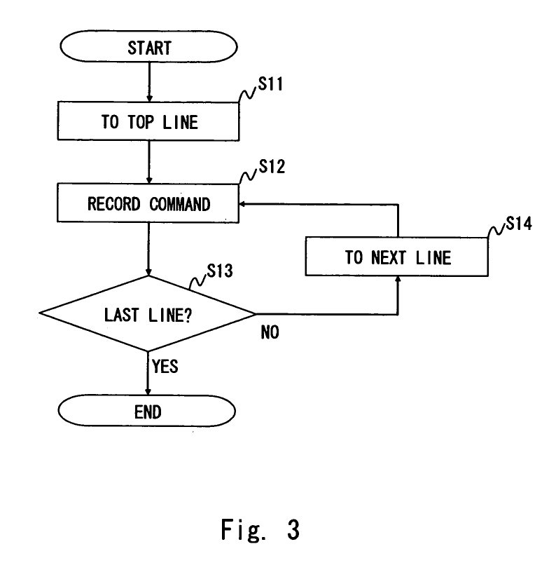

The processing of each step in the flowchart of FIG. 2 is described in detail. FIG. 3 is a detailed flowchart of a processing flow during execution of the monitoring script.

First of all, a command described in the top line of the monitoring script is executed (S11). The monitoring script lists monitoring commands that describe which value in the user system is to be monitored upon the verification of the user system, which is independent of the order of command processings, but the command control unit 30 of the host computer 3 executes the monitoring script from the first command line.

The monitoring command on the first line is sent to the user system 2 through the communication unit 33 under the control of the command control unit 30. The user system 2 receives the monitoring command on the first line through the communication unit 23. The monitoring command is not a synchronous command that triggers a processing in response to the input of the command but an asynchronous command that executes the transmission of data about the continuous monitoring result, so the command is stored in the storage unit 32 (S12).

After the monitoring command on the top line is stored in the storage unit 22, it is checked whether or not there is a monitoring command on the next line (S13). If the monitoring command is detected on the next line, the process shifts to the monitoring command on the next line (S14), and the command is stored in the storage unit 22. If there is no monitoring command on the next line, the current line is the last line, so the process ends there.

The monitoring command stored in the storage unit 32 is continuously executed during a subsequent verification operation. In this way, it is possible to confirm a change in monitoring result according to the operation under the verification.

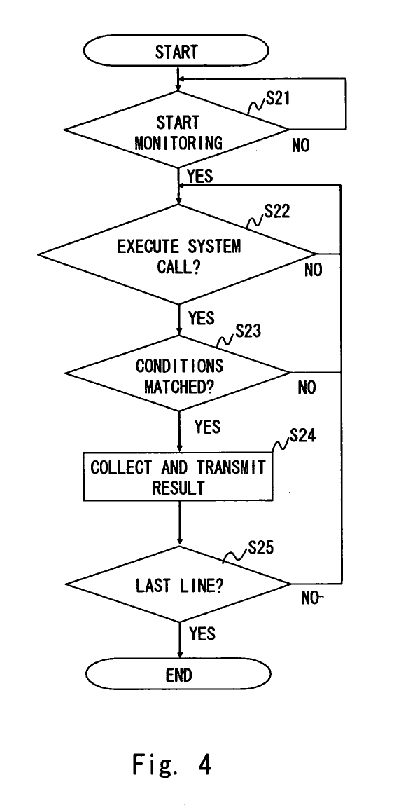

FIG. 4 is a detailed flowchart of a monitoring processing flow. First of all, the control unit 20 of the user system 2 checks whether or not the monitoring processing starts (S21). This confirmation is repeated until the monitoring processing is started.

Next, the control unit 20 determines whether or not the system calls to execute the command (S22). This determination is repeated until the system calls to execute the command. Once the system calls to execute the command, it is determined whether or not the called command matches with a monitoring command stored in the storage unit 22 (S23). If matched, the data about the processing described in the monitoring command is sent as result information through the communication unit 23 (S24). If not matched, the process returns to the step of determining whether or not the system calls to execute the command.

At the completion of the data transmission, the control unit 20 determines whether or not the monitoring processing is completed (S25). If not completed, the returns to the step of determining whether or not the system calls to execute the command. If completed, the monitoring process ends there.

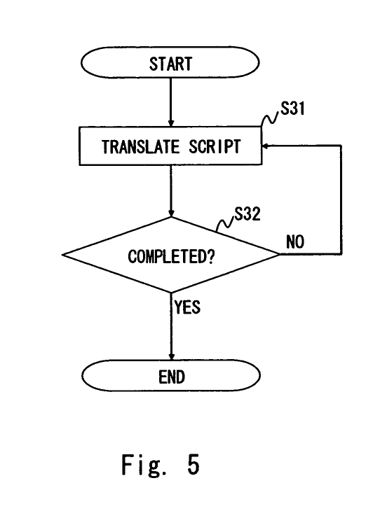

FIG. 5 is a detailed flowchart of a flow of an evaluating script creating processing. The script creating unit 31 translates received processing information into commands that compose a script in a time-series manner (S31). The translation is carried out based on an evaluating script translation rule stored in the storage unit 32. After the completion of translation of one processing information, it is determined whether or not the next processing information is input (S32) If the determination result shows that the next processing information is input, the next processing information is translated into a script in the same way. At this time, a time difference between the current processing information and the preceding processing information is recorded, and a wait command corresponding to the time difference is inserted. With this operation, it is possible to check the malfunction of the time-dependent operation.

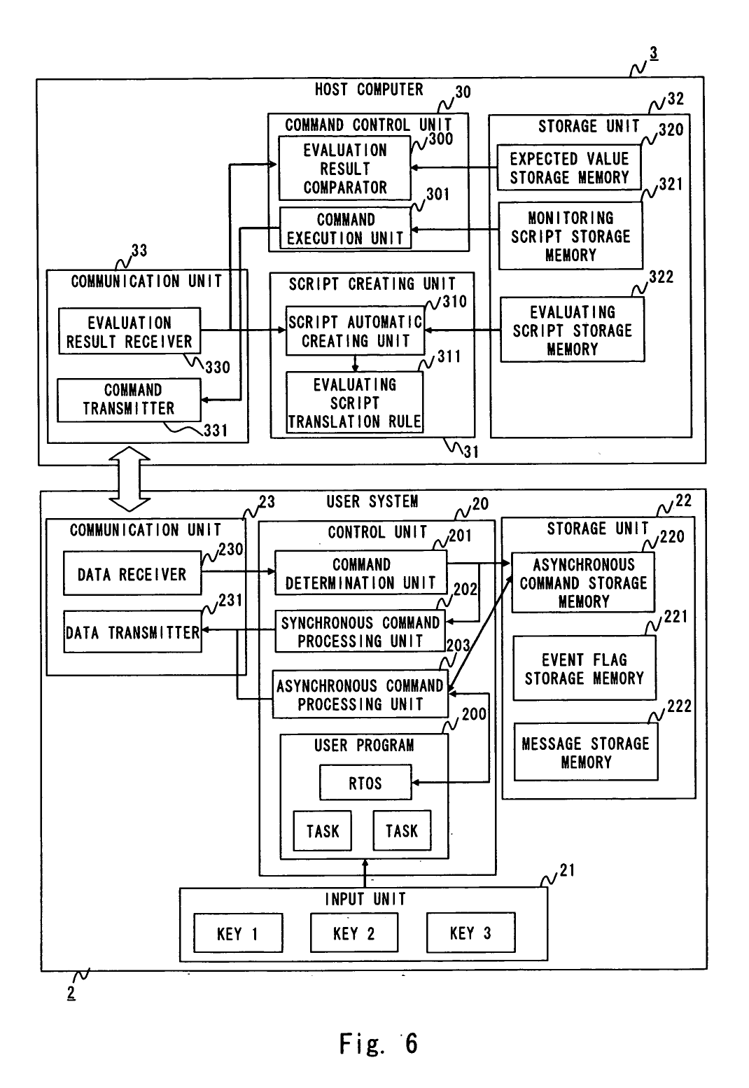

From now on, the above processing is described in detail taking a specific example. FIG. 6 is a block diagram showing the configuration of the verifying system according to the present invention. The overall configuration is the same as that shown in the block diagram of FIG. 1, and the verifying system 1 includes the user system 2 and the host computer 3.

The user system 2 includes the control unit 20, the input unit 21, the storage unit 22, and the communication unit 23. The control unit 20 includes a user program 200, a command determination unit 201, a synchronous command processing unit 202, and an asynchronous command processing unit 203.

The user program 200 includes a real-time operating system (RTOS) and one or more tasks executed on the RTOS. The RTOS is an operating system for running the user program 200 and is mainly used for an embedded system. The tasks are various kinds of processings executed on the RTOS. The asynchronous command is executed by the asynchronous command processing unit as follows: the asynchronous command processing unit 203 executes the command in response to a system call issued during the task of the user program 200.

The command determination unit 201 determines whether the command received from the host computer 3 is a synchronous command or asynchronous command. If the determination result shows that the command is the synchronous command, the synchronous command processing unit 202 executes the command at once. If the determination result shows that the command is asynchronous command, the command is stored in an asynchronous command storage memory 220 of the storage unit 22. Further, the aforementioned monitoring command is a continuous monitoring command independent of a timing and thus is an asynchronous command.

The synchronous command processing unit 202 executes the synchronous command if the command determination unit 201 determines that the command is the synchronous command. The asynchronous command processing unit 203 executes a command independent of a command input timing. The asynchronous command processing unit 203 executes the asynchronous command stored in the asynchronous command storage memory 220 in response to a system call issued during the task of the user program 200.

The input unit 21 includes three keys of keys 1 to 3. If the key 1 is depressed, a system call A for setting a pattern to an event flag 1 is issued. If the key 2 is depressed, a system call B for setting a pattern to an event flag 2 is issued. If the key 3 is depressed, a system call for sending a message is issued.

The storage unit 22 includes the asynchronous command storage memory 220 storing the asynchronous commands, an event flag storage memory 221 storing the event flag state, and a message storage memory 222 storing message data. The storage unit 22 further stores programs and various variables.

The communication unit 23 includes a data receiver 230 and a data transmitter 231. The data receiver 230 receives a command from the host computer 3. The data transmitter 231 sends a command and a value stored in the storage unit 22 to the host computer 3. At this time, which value is sent is determined based on the monitoring command.

The host computer 3 includes the command control unit 30, script creating unit 31, the storage unit 32, and the communication unit 33. The command control unit 30 includes an evaluation result comparator 300, and a command execution unit 301. The evaluation result comparator 300 compares the value received from the user system 2 with a value in an expected value storage memory 320 of the storage unit 32 to determine whether or not the user system 2 normally operates. The command execution unit 301 receives the scripts stored in a monitoring script storage memory 321 and an evaluating script storage memory 322 of the storage unit 32 to send the commands in the script to the user system 2 through a command transmitter 331 in the communication unit 33.

The script creating unit 31 records commands corresponding to the processing information, which are received from the user system 2 through the communication unit 33 in a time-series manner to create a script. The storage unit 32 includes the expected value storage memory 320, the monitoring script storage memory 321, and the evaluating script storage memory 322.

The communication unit 33 includes an evaluation result receiver 330, and a command transmitter 331. The evaluation result receiver 330 receives the processing information and a value stored in the storage unit 22 from the user system 2. The command transmitter 331 sends commands from the command execution unit 301 to the user system 2.

Next, the evaluating script creation processing flow is explained taking a specific example. An evaluation target is an operation in which the key 1 is input, and the key 2 is input after 2 seconds, and then the key 3 is input after 3 seconds. The monitoring-target information is an event flag 1, an event flag 2, and a message box. Data about the event flags 1 and 2 are stored in the event flag storage memory 221, and data about the message box is stored in the message storage memory 222.

For the first verification, a user needs to perform the above operation in practice. The user actually performing the operation, the user program 200 detects the key input information with the input unit 21 to let the control unit 20 execute processings corresponding to the input key.

At this time, the control unit 20 measures the intervals of the key inputs to record it as well as executes the processing corresponding to the key inputs. The control unit 20 sends, if the executed processing corresponding to the monitoring data, the processing information about the executed processing and the information about the intervals of the key input to the host computer 3 by use of the data transmitter 231.

Receiving the processing information and the information about the key input intervals by use of the evaluation result receiver 330, the host computer 3 outputs the information to a script automatic creating unit 310. The script automatic creating unit 310 references an evaluating script translation rule 311 based on the received processing information and the key input intervals to create the evaluating script. The created evaluating script is stored in the evaluating script storage memory 322.

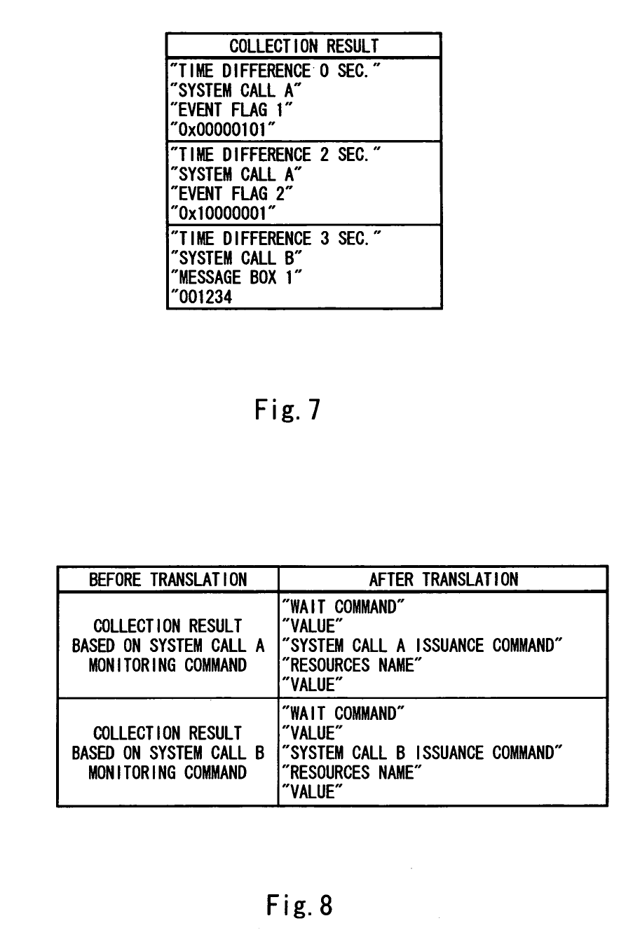

FIG. 7 shows an example of the received processing information and the key input intervals. FIG. 8 shows an example of the evaluating script translation rule 311. The script automatic creating unit 310 receives the processing information and the key input intervals of FIG. 7 as a collection result to create an evaluating script with reference to the evaluating script translation rule of FIG. 8. For example, the processing information such as a time difference of 0 sec., “system call A”, “event flag 1”, and “0×00000101” is received, and then translated into the evaluating script with reference to the evaluating script translation rule 311. In this example, the system call A is set, so the processing information is translated into a script of “wait command”, “value”, “system call A issuance command”, “resources name”, and “value”.

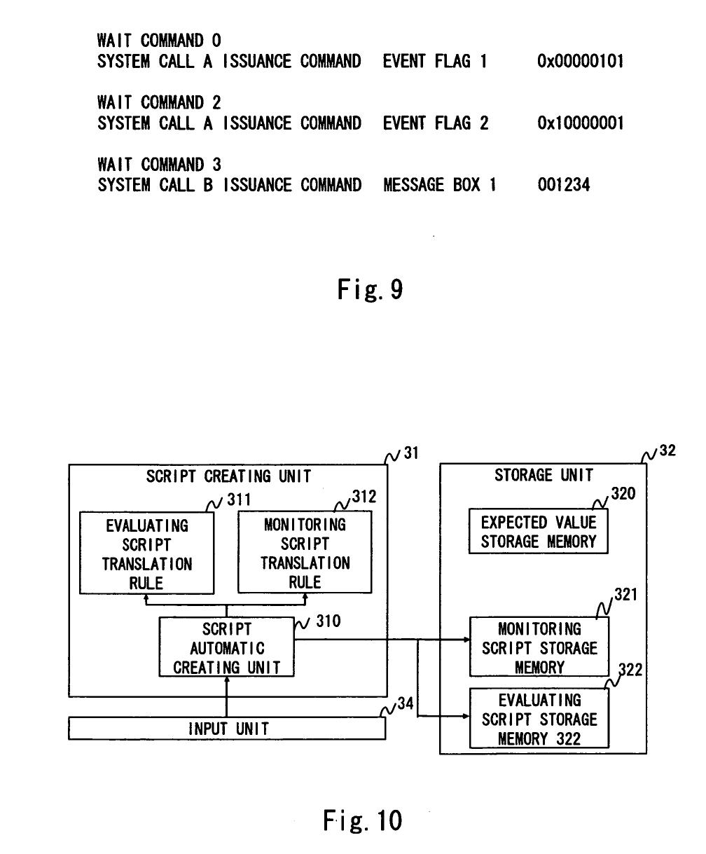

FIG. 9 shows the created evaluating script. The wait command indicates how long the wait processing is continued. The system call A issuance command, and system B issuance command are processing information created to each key input. The event flags 1 and 2, and the message box 1 are independently set data, and values of 0×0000101, 0×100000001, and 001234 are respectively set.

In the reverification, the script stored in the evaluating script storage memory 322 is analyzed without any user operation, and the command execution unit 301 transmits the command to the user system 2 through the command transmitter 331. The user system 2 receives the command by use of the data receiver 230. The evaluating script is a synchronous command and thus is output to the synchronous command processing unit 202 through the command determination unit 201. The synchronous command processing unit 202 receives the command to execute the processing corresponding to the received command.

In this way, the host computer 3 receives a command created in accordance with the input operation of the user system 2 to create a script, which saves time and effort in repeating the operation for the reverification. Further, it is unnecessary to describe the script, which saves time and effort in creating the script.

### Second Embodiment

It is possible to automatically create the monitoring script as well as the evaluating script. FIG. 10 is a block diagram showing only a portion of the host computer 3 different from that of the first embodiment in a verifying system according to a second embodiment of the present invention. The configuration of the second embodiment is the same as the configuration shown in the block diagram of FIG. 6 except for the portion shown in FIG. 8.

The second embodiment differs from the first embodiment in that the host computer 3 includes an input unit 34 for inputting monitoring script creation data, and a monitoring script translation rule 312 for creating the monitoring script.

The input unit 34 receives information about processing to be monitored by use of an interface such as a graphical user interface (GUI) on the host computer 3. The received information is sent to the script automatic creating unit 310.

The script automatic creating unit 310 receives the monitoring-target processing information to create a monitoring script with reference to the monitoring script translation rule 312. The created monitoring script is stored in the monitoring script storage memory 321.

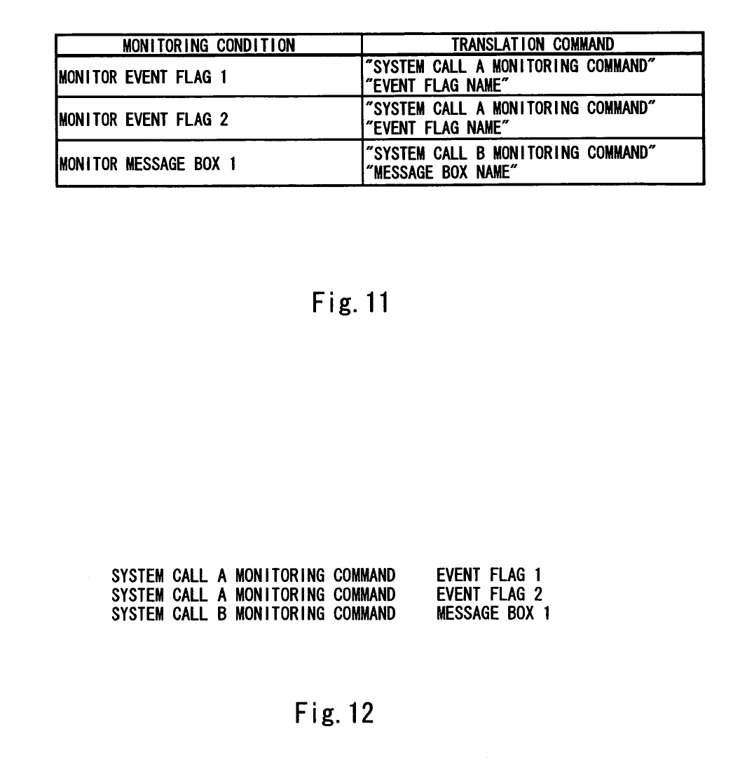

FIG. 11 shows an example of the monitoring script translation rule 312. The monitoring condition of FIG. 11 designates the monitoring-target operation information, and the translation command indicates a command of the monitoring script to be translated. If the operation information that defines the event flag 1 as a monitoring target is input, the “system call A monitoring command”, and “event flag name” command are created. FIG. 12 shows an example of the created monitoring script.

As mentioned above, the monitoring script can be also created using an interface of high operability such as a GUI without describing the script, which further reduces the verification time and effort.

It is apparent that the present invention is not limited to the above embodiment that may be modified and changed without departing from the scope and spirit of the invention.

What is claimed is:

1. A verifying system comprising:
a user system; and
a host computer for sending a command based on a script to the user system and verifying a command execution result, wherein
the user system comprising:
an instruction input unit for inputting a user's instruction;
a processing monitoring unit for monitoring a processing executed in accordance with an instruction input by the instruction input unit; and
a transmitter for transmitting processing information based on the processing monitored by the processing monitoring unit to the host computer, and wherein
the host computer comprising:
a processing information receiver for receiving the processing information from the user system;
a script creating unit for creating a script that records commands corresponding to the processing information received by the processing information receiver in a time-series manner; and
a script storage unit for storing the script created by the script creating unit.

2. The verifying system according to claim 1, wherein
the host computer further includes a command transmitter for transmitting a command based on the script stored in the script storage unit to the user system, and
the user system further includes a receiver for receiving the command from the host computer, and a command execution unit for executing the command received by the receiver.

3. The verifying system according to claim 1, wherein the script creating unit records a wait command for causing the user system to wait for a time period corresponding to an operation interval of commands received by the command receiver, between the received commands.

4. The verifying system according to claim 3, wherein the user system further includes a time measuring unit for measuring an input time interval of instructions, and wherein the transmitter of the user system transmits the input time interval measured by the time measuring unit, the command receiver of the host computer receives the input time interval from the transmitter, and the script creating unit of the host computer records a wait command based on the received input time interval.

5. The verifying system according to claim 1, wherein the host computer further includes:
a monitoring instruction input unit for inputting a monitoring instruction for the user system;
a monitoring script creating unit for creating a monitoring script for causing the user system to execute a command based on the monitoring instruction input by the monitoring instruction input unit; and
a monitoring script storage unit for storing the monitoring script created by the monitoring script creating unit.

6. A verifying method for transmitting a command to a user system based on a script from a host computer and verifying a command execution result at the host computer, comprising:
inputting an instruction at the user system;
monitoring a processing based on the instruction at the user system;
transmitting processing information based on the monitored processing from the user system to the host computer; and
receiving the processing information at the host computer to create a script that records commands corresponding to the processing in a time-series manner.

7. The verifying method according to claim 6, further comprising transmitting a command based on the created script to the user system upon reverification, and executing a processing of the received command at the user system.

8. The verifying method according to claim 6, wherein the script includes a wait command for causing the user system to wait for a time period corresponding to an operation interval of received commands, between the received commands.

9. The verifying method according to claim 6, further comprising:
inputting a monitoring instruction at the host computer; and
creating a monitoring script that lists monitoring commands based on the input monitoring instruction at the host computer.
